(19) United States
(12) Patent Application Publication
(10) Pub. No.: US 2012/0131037 A1
(43) Pub. Date: May 24, 2012

(54) ASYNCHRONOUS ONLINE SEARCHES

(75) Inventor: Suyash Sinha, Kirkland, WA (US)

(73) Assignee: Microsoft Corporation, Redmond, WA (US)

(21) Appl. No.: 12/949,772

(22) Filed: Nov. 18, 2010

(51) Int. Cl. G06F 17/30

(52) U.S. Cl. 707/769; 707/E17.014

(57) ABSTRACT

The claimed subject matter provides a method for generating asynchronous search results. The method includes receiving an asynchronous search request from a browser. The method also includes requesting asynchronous results from an asynchronous query system. Additionally, the method includes performing a synchronous search based on the asynchronous search request. The synchronous search generates initial results. The method further includes providing the initial results to the browser. Also, the method includes providing, to the browser, an estimated completion time when the asynchronous results are made available.

### BACKGROUND

Online searching is a synchronous experience from the perspective of an end-user. The user typically waits after typing in the search query to see the results of the query displayed in the browser. The components of the online search are performed in sequence, with the entire transaction completed in a matter of seconds. The user types search terms into a search engine using their browser and hits enter. The browser usually bundles the query into network packets which are sent over a TCP/IP network to the search engine servers. The servers perform the search on a database of catalogued data, and send back an answer to the user's request. The answer may include links to numerous websites, shown within a web browser.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The subject innovation relates to a method and a system for generating asynchronous search results. The method includes receiving an asynchronous search request from a browser. The method also includes requesting asynchronous results from an asynchronous query system. Additionally, the method includes performing a synchronous search based on the asynchronous search request. The asynchronous search generates initial results. The method further includes providing the initial results to the browser. Also, the method includes providing, to the browser, an estimated completion time when the asynchronous results are made available.

An exemplary system according to the subject innovation may be used for generating asynchronous search results. The exemplary system comprises a processing unit and a system memory that comprises code configured to direct the processing unit to determine that asynchronous results are available. The code may also be configured to direct the processing unit to request the asynchronous results. In particular, the code may be configured to direct the processing unit to notify a user that the asynchronous results are available, and display the asynchronous results.

Another exemplary embodiment of the subject innovation provides one or more computer readable storage media that include code to direct the operation of a processing unit. In one exemplary embodiment, the code may direct the processing unit to receive a request for a search site from a user of the browser. The search site comprises a server that supports an asynchronous search request. The code may also be configured to direct the processing unit to submit a request to the search site. Further, the code may be configured to direct the processing unit to receive a response from the search site. The response indicates that the search site supports the asynchronous search request. In particular, the code may be configured to direct the processing unit to display an icon clickable to send the asynchronous search request to the search site.

The following description and the annexed drawings set forth in detail certain illustrative aspects of the claimed subject matter. These aspects are indicative, however, of a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 is a process flow diagram of a method for asynchronous searching according to the claimed subject matter;

FIGS. 2A-2D are block diagrams of web browser clients in accordance with the claimed subject matter;

FIG. 3 is a process flow diagram of a method for submitting a search request in accordance with the claimed subject matter;

FIG. 4 is a process flow diagram of a method for responding with a completion time in accordance with the claimed subject matter;

FIG. 5 is a process flow diagram of a method for displaying asynchronous search results in accordance with the claimed subject matter;

FIG. 6 is a block diagram of an exemplary networking environment wherein aspects of the claimed subject matter can be employed; and

FIG. 7 is a block diagram of an exemplary operating environment for implementing various aspects of the claimed subject matter.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” “browser,” “search engine,” “client” and the like are intended to refer to a computer-related entity, either hardware, software (e.g., in execution), and/or firmware. For example, a component can be a process running on a processor, an object, an executable, a program, a function, a library, a subroutine, and/or a computer or a combination of software and hardware.

By way of illustration, both an application running on a server and the server can be a component. One or more components can reside within a process and a component can be localized on one computer and/or distributed between two or more computers. The term “processor” is generally understood to refer to a hardware component, such as a processing unit of a computer system.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any non-transitory computer-readable device, or media.

Non-transitory computer-readable storage media can include but are not limited to magnetic storage devices (e.g., hard disk, floppy disk, and magnetic strips, among others), optical disks (e.g., compact disk (CD), and digital versatile disk (DVD), among others), smart cards, and flash memory devices (e.g., card, stick, and key drive, among others). In contrast, computer-readable media generally (i.e., not necessarily storage media) may additionally include communication media such as transmission media for wireless signals and the like.

Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

Performing asynchronous searches may be useful in scenarios where a delayed result may be acceptable to a user. Some example scenarios include users searching on complex terms, users wanting answers to a question more easily answered by a human being or crowd-sourcing, or users on faulty/lossy networks, e.g., an ad-hoc wireless mesh. In such scenarios, the user may be willing to tolerate a longer search completion time in exchange for getting information which may not otherwise be available. With an asynchronous search, results can be provided to these users that are willing to wait.

In some regions of the world, access to communications is characterized by high latency and low bandwidth. In such regions, the asynchronous described herein may can provide a mechanism for people to search online and get results a few minutes later. Typical search engines cannot provide results in this manner because TCP connections to search engines can time out before the results can be made available to the user.

To illustrate embodiments of asynchronous searches, an example of asynchronous search is provided. This example shows how an online asynchronous search works in an end-to-end fashion for a typical search engine. It should be noted that search engines are merely one example of a type of website that may perform asynchronous searches. Other websites with searching capabilities may also be used in some embodiments.

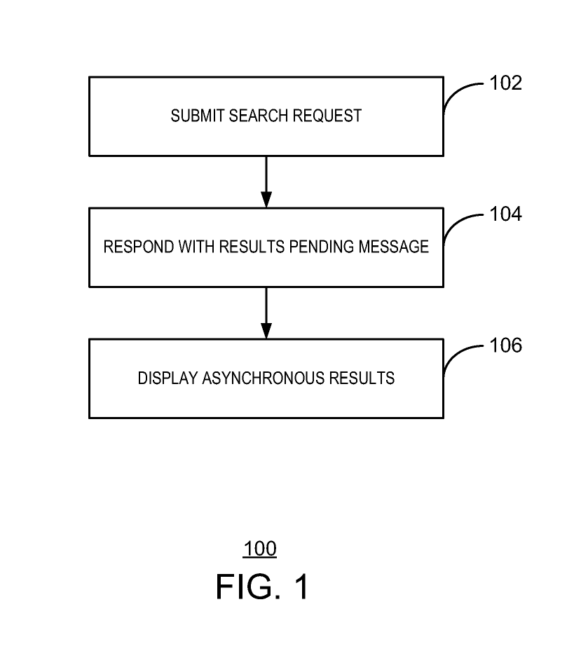

FIG. 1 is a process flow diagram of a method 100 for asynchronous searching according to the claimed subject matter. It should be understood that the process flow diagram is not intended to indicate a particular order of execution. In some exemplary embodiments, modifications may be made to traditional browsers, search front-end infrastructures, and search back-end infrastructures. The method 100 may be performed by these browsers and end-to-end infrastructures.

The method 100 may begin at block 102, where the browser may submit a search request to a search engine. In response, at block 104, the search engine may respond with a results pending message. In some exemplary embodiments, the results pending message may include an expected completion time. The user may move on to other activities while the search is performed. At block 106, the browser may display the search results on or around the expected completion time.

The entire asynchronous search transaction may be completed in seconds, minutes, or longer. In one exemplary embodiment, the user may receive a notification when results become available. In some exemplary embodiments, the notification may be an email containing the results, or a link thereto.

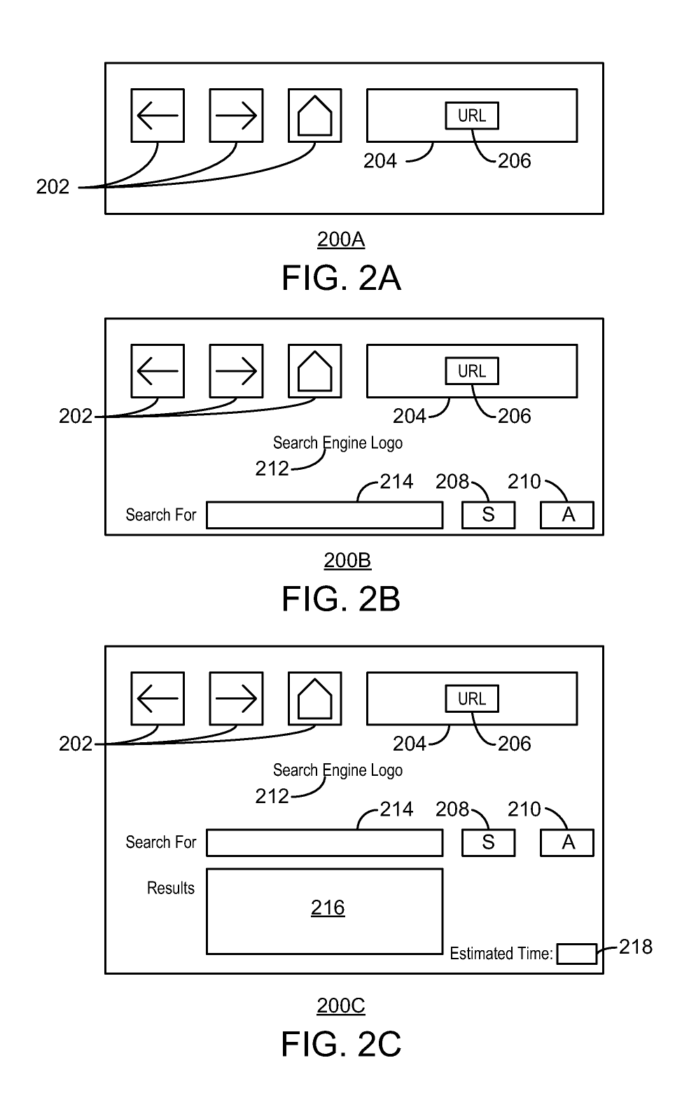

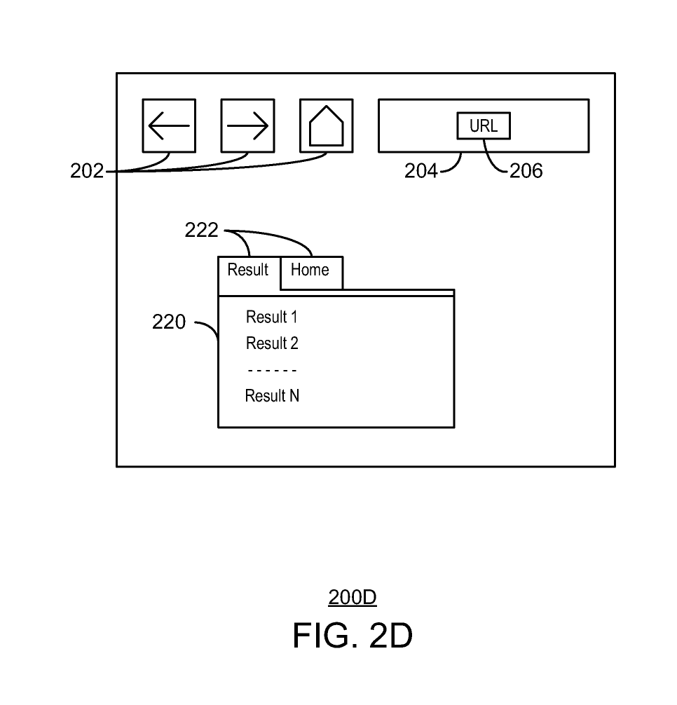

The method 100 is described in greater detail with reference to FIGS. 2-5. FIGS. 2A-2D are block diagrams of browser clients 200A-D in accordance with the claimed subject matter.

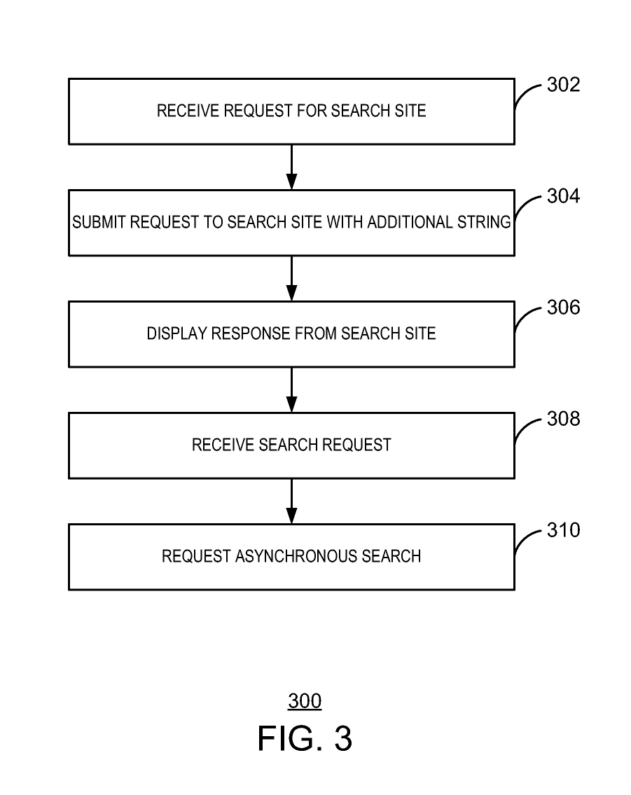

FIGS. 3-5 are process flow diagrams describing blocks 102, 104, and 106 in greater detail.

The browser clients 200A-D shown are interfaces that are configured by a larger piece of software, also called a browser client, or simply a browser. As understood by one skilled in the art, the browser also performs other functions to interface with web servers across communication networks like the Internet. In the descriptions with reference to FIGS. 2-5, the terms browser and web client 200A-D, are used to describe the overall browser software, and the interfaces configured by it, respectively.

As shown in the following example of an asynchronous search, modifications to a standard browser may enable a user to request and receive asynchronous search results. To request an asynchronous search, the user may navigate to a search engine website using the web browser client 200. Alternatively, the user may operate a plug-in to the browser, entering the search terms into an interface provided by the plug-in.

FIG. 2A is a block diagram of a browser client 200A in accordance with the claimed subject matter. The client 200A includes standard navigation buttons 202 and an address bar 204. The buttons 202 may be used to navigate between web pages.

FIG. 3 is a process flow diagram of a method 300 for submitting a search request in accordance with the claimed subject matter. The method 300 may be performed by the browser.

At block 302, the browser may receive a request for a search site. The search site may be a website with search capability, e.g., a search engine website. In one exemplary embodiment, the user may enter a uniform resource locator (URL) 206 in the address bar 204. The URL 206 may be an ftp, http, or other Internet address for the search engine. For example, the user may navigate an Internet Explorer® browser by entering the URL for the Microsoft Bing™ website in the address bar 204.

In response to receiving the URL, the browser may make a request to the web server hosting the website requested. In the above example, the browser sends a request to the web server hosting the Bing™ website. Unseen to most users, when the browser sends the initial request to the web server, the request includes an identification known as a user agent string. (UA string). The browser may compose the UA string to provide general information to the web servers. The web servers use this general information to interpret data from, and send data to, the computer hosting the browser. For example, the UA string may identify the browser software, attached devices, operating system capabilities, etc., of the user's computer.

At block 304, the browser may submit an initial request to the search site. The initial request may be for a web page, e.g., home page, from a search engine website. The initial request may include the URL 206 and an additional string. The additional string may represent a request asking if the search engine at the specified URL supports asynchronous searches. When the user enters the search engine URL 206 in the address bar 204, the browser may append the UA string and the additional string in an http request to the search engine.

In addition to browser modifications, search engine front-end modifications may enable browsers to request asynchronous searches and provide asynchronous search results. For example, web servers that recognize the additional string in the initial request may send a response that specifies whether the website supports asynchronous searches. Web servers that do not recognize the additional string may ignore it.

At block 306, the browser may display the response from the search site. FIG. 2B is a block diagram of browser client 200B in accordance with the claimed subject matter. The client 200B may represent the response from the search engine. In one embodiment, the response to a search request with the additional string may include hypertext to make the browser render an icon clickable to request asynchronous searches.

As shown, the client 200B includes the web page for the search engine. The elements of the web page include a logo 212, an entry box 214, a synch search button 208, and an asynch search button 210. The buttons 208, 210 may be located at the end of the entry box 214. The button 208 may be clickable to request traditional, synchronous searches. The appearance of the button 210 may indicate that the search engine supports asynchronous searches, and may be clickable to request an asynchronous search.

At block 308, the browser may receive the search request. Typical search engines provide a single entry box 214 for entering search terms. The user may type the search terms into the entry box 214.

For a traditional search, the user may type search terms, “operating systems” in the dialog box and click the button 208 at the far right of the entry box 214. In response, at block 310, the browser may request an asynchronous search from the search engine.

The browser may generate a parameterized uniform resource locator (URL) 206 for the request. The URL 206 may include a website address and a request string.

The request string may include the search terms. For example, a substring of the request string could be “search?q=operating+systems.” The request string specifies a standard synchronous search for items matching to the terms “operating” and “systems.”

If the user had typed in “operating systems,” (with the quotes around the entire phrase) the browser would send a different URL. In such a case, the substring may be “%22operating+systems %22.” The “%22” around the phrase stands for the quotes.

If, instead of the synch search button 208, the user clicks the asynch search button 210, a pre-loaded client-side script of the browser may send a different URL to the search engine. For example, the substring described above may be changed to “search?a=operating+systems.” In this example, the “q” used in a synchronous search is changed to “a,” for asynchronous search.

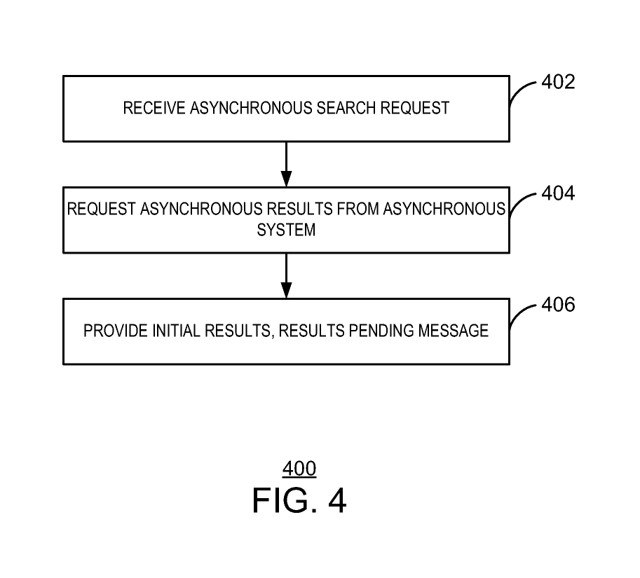

FIG. 4 is a process flow diagram of a method 400 for responding with a completion time in accordance with the claimed subject matter. The method 400 may be performed by the search engine. At block 402, the search engine may receive the asynchronous search request, which includes the URL specifying the search request. At block 404, the search engine may request asynchronous results from an asynchronous query system. The search engine may send the URL, or a substring of the URL, to the asynchronous query system.

The asynchronous query system may be incorporated into a search engine back end infrastructure to generate asynchronous search results. In some embodiments, actual human or crowd-sourcing resources may be used in the back end infrastructure to generate the results of an asynchronous search.

In crowd-sourcing, a member of a community such as an on-line community may receive a small payment of money or a token that may be exchanged for money for providing a satisfactory response to a user request. Moreover, crowd-sourcing may be useful for finding information that may not readily be obtained by a traditional search engine, such as an item of information that is specific to a particular locality, for example.

The asynchronous query system may include a group of responders that are willing to seek out information requested in asynchronous searches. The responders connect with the backend to the search engine using a well-defined interface. Using this interface, the search engine backend sends the responder a message containing the query, and the responder's responses are send back as messages to the search backend. Asynchronous search requests may be sent to such a group of people over SMS, phone, email, etc. These responders may include crowd-sourcing resources.

While the asynchronous query system may eventually provide results, the user may be waiting for a synchronous response from the search engine. In one embodiment, the search engine may also search its backend database for results, just as done in a typical search engine request.

The synchronous search results may be sent with a message indicating that an asynchronous query is pending. Accordingly, at block 406, the search engine may provide the synchronous search results, i.e., the initial results. The search engine may also provide a “results pending” message, or alternatively, an estimated completion time of the asynchronous search. The estimated completion time may be when the asynchronous results are made available.

FIG. 2B is a block diagram of browser client 200B in accordance with the claimed subject matter. As shown, an estimated completion time 218 of the asynchronous result search may be displayed on the web page along with the synchronous search results 216.

The message may further include an identifier that the browser may use to identify the asynchronous search request. Using this identifier, the browser may maintain a session with the search engine web servers longer than that of a traditional synchronous search. The length of the session may span the time interval between the initial search request, and the estimated time when the asynchronous search finishes.

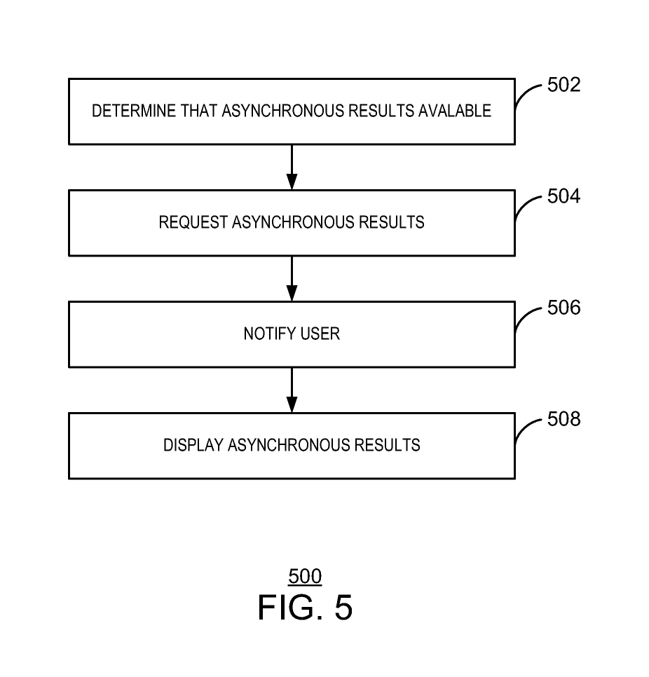

FIG. 5 is a process flow diagram of a method 500 for displaying asynchronous search results in accordance with the claimed subject matter. The method 500 may be performed by the browser, the search engine, the asynchronous query system, or some combination. The method begins at block 502, where it may be determined that asynchronous results are available. Accordingly, at block 504, the asynchronous results may be requested.

In one exemplary embodiment, the browser may create a local timer that expires after the estimated time. Once the timer expires, a timer callback may send a URL request to the search engine specifying the identifier. In some exemplary embodiments, the timer callback may be part of the browser functionality.

At block 506, the user may be notified that the results are available. In response to the browser's URL request, the search engine may send the asynchronous search results back to the browser. Once the asynchronous results are received at the browser, the browser callback may present a non-intrusive notification icon on the browser interface.

At block 508, the asynchronous results may be displayed. When the user clicks the notification icon, the browser callback may render a web-page with the asynchronous query results. In a multi-user system, the result notification may be tracked by an association of user sessions, ensuring that asynchronous results are provided to the user requesting them.

In one embodiment, the results may be presented in an additional tab added to the browser interface. FIG. 2D is a block diagram of web browser client 200D in accordance with the claimed subject matter. The client 200D includes tabs 222, with the asynchronous results 220 displayed on the tab labeled result. In one exemplary embodiment, the results 220 may be displayed on a newly added tab 222. Only the newly added tab 222 may be displayed. In this manner, the user may be notified of the result being available, without having intruded on the user's current web browsing experience.

Alternatively, the user may specify an email address for receiving the results. Accordingly, the asynchronous results may be sent to the specified email address by the search engine, the asynchronous query system, or the browser.

Business models to incentivize the responders may vary. In one embodiment, a micro-transaction model may reward responders with points that can be redeemed for goods. Alternatively, responders may receive small sums, e.g., a few cents for every response.

In another exemplary embodiment, rewards may be based on a rating by the user. If the user likes a particular response, the responder is rewarded. In such an embodiment, the user can select a favored response in the asynchronous query results, completing a feedback loop.

This model may be useful for searches such as, “What is the price of a bouquet of lilies in the Pike Place Market today?” Results to this type of search may not be available from synchronous searches, but may be available through asynchronous techniques such as crowd-sourcing. Advantageously, a user interested in such answers may also be willing for pay a few cents for the answer.

In one exemplary embodiment, third party solutions may be built on top of such technology in the search engine. One example of such a solution could involve a third party with access to human responders from a subscription base, e.g., parents of young kids. These responders may fit into a statistical profile, such as “experienced parents of toddlers.” A user query such as, “What should I do if my toddler is throwing up after drinking milk?” can be directed to a third party with such a statistical profile.

The third party may then send the query message to its subscribed customers or responders who fit the statistical profile. Responders could then send back a response through the third party, and the response would be finally fulfilled by the search engine. The user's satisfaction with the answers may cause the responder to be rated higher. If certain responders get consistently high ratings for their responses, the third party could, using the data, demand higher ad-revenue for products and services on that responder's blogs.

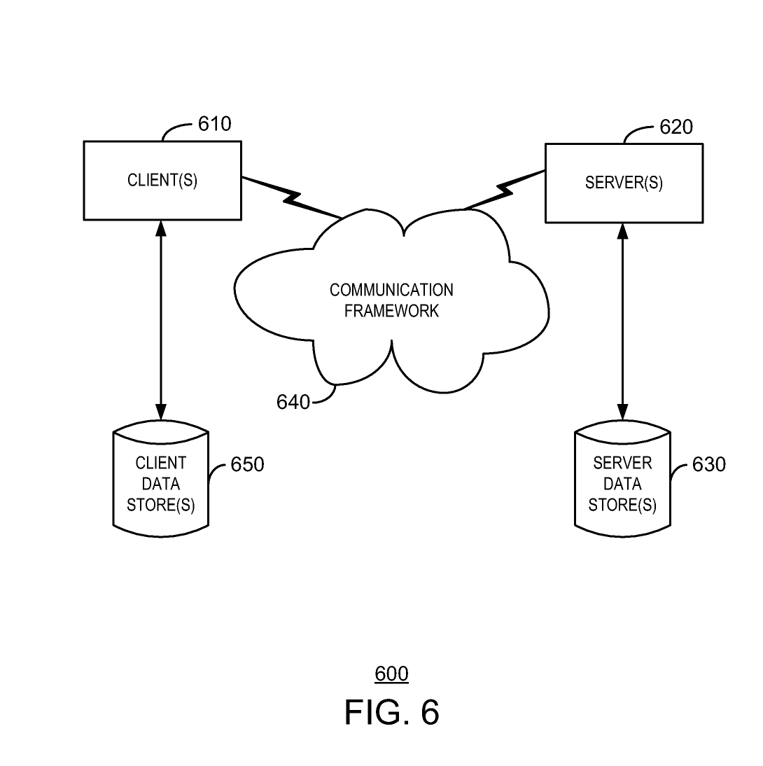

FIG. 6 is a block diagram of an exemplary networking environment 600 wherein aspects of the claimed subject matter can be employed. Moreover, the exemplary networking environment 600 may be used to implement a system and method of performing asynchronous searches. The asynchronous search results may be generated by an infrastructure back-end that may include human resources, crowd-sourcing resources or the like.

The networking environment 600 includes one or more client(s) 610. The client(s) 610 can be hardware and/or software (e.g., threads, processes, computing devices). As an example, the client(s) 610 may be computers providing access, for users of a web browser, to servers over a communication framework 640, such as the Internet.

The networking environment 600 also includes one or more server(s) 620. The server(s) 620 can be hardware and/or software (e.g., threads, processes, computing devices). The server(s) 620 may include search engine web servers, or other servers that support asynchronous searches.

The server(s) may be accessed by the client(s) 610. The servers 620 can house threads to indicate support for asynchronous searches, and to provide asynchronous search results to the client(s) 610.

One possible communication between a client 610 and a server 620 can be in the form of a data packet adapted to be transmitted between two or more computer processes. The networking environment 600 includes a communication framework 640 that can be employed to facilitate communications between the client(s) 610 and the server(s) 620.

The client(s) 610 are operably connected to one or more client data store(s) 650 that can be employed to store information local to the client(s) 610. The client data store(s) 650 may be located in the client(s) 610, or remotely, such as in a cloud server. Similarly, the server(s) 620 are operably connected to one or more server data store(s) 630 that can be employed to store information local to the servers 620.

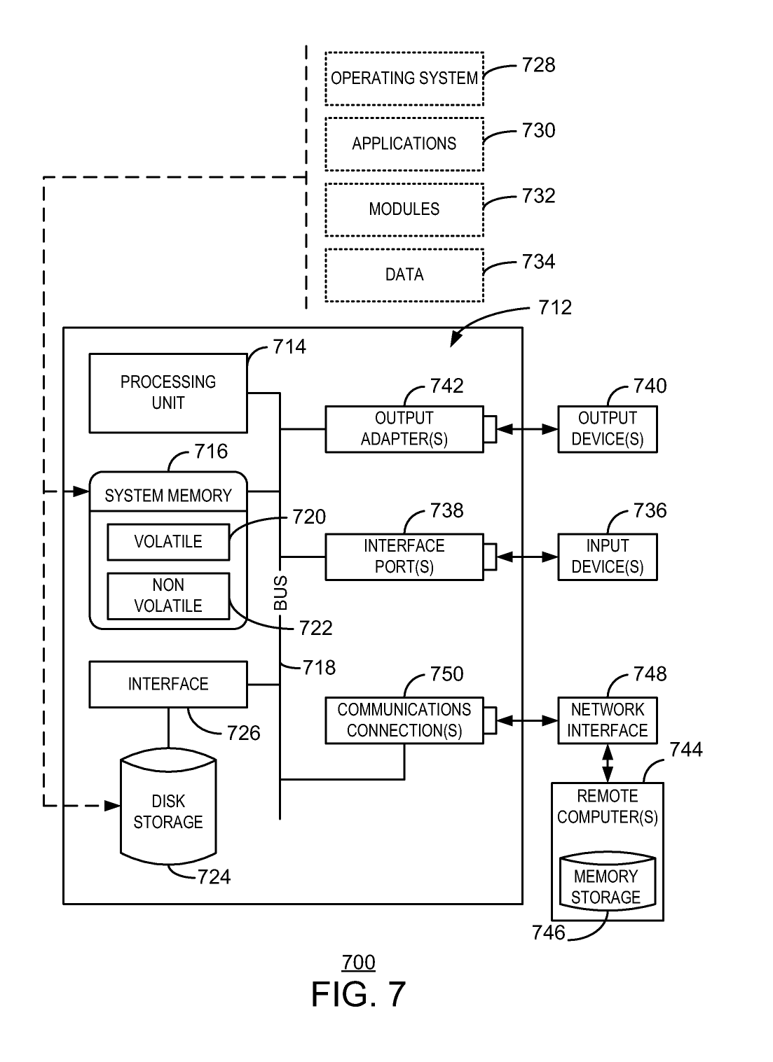

With reference to FIG. 7, an exemplary operating environment 700 for implementing various aspects of the claimed subject matter. The exemplary operating environment 700 includes a computer 712. The computer 712 includes a processing unit 714, a system memory 716, and a system bus 718.

The system bus 718 couples system components including, but not limited to, the system memory 716 to the processing unit 714. The processing unit 714 can be any of various available processors. Dual microprocessors and other multiprocessor architectures also can be employed as the processing unit 714.

The system bus 718 can be any of several types of bus structure(s) including the memory bus or memory controller, a peripheral bus or external bus, and/or a local bus using any variety of available bus architectures known to those of ordinary skill in the art. The system memory 716 is non-transitory computer-readable media that includes volatile memory 720 and nonvolatile memory 722.

The basic input/output system (BIOS), containing the basic routines to transfer information between elements within the computer 712, such as during start-up, is stored in nonvolatile memory 722. By way of illustration, and not limitation, nonvolatile memory 722 can include read only memory (ROM), programmable ROM (PROM), electrically programmable ROM (EPROM), electrically erasable programmable ROM (EEPROM), or flash memory.

Volatile memory 720 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), SynchLink™ DRAM (SLDRAM), Rambus® direct RAM (RDRAM), direct Rambus® dynamic RAM (DRDRAM), and Rambus® dynamic RAM (RDRAM).

The computer 712 also includes other non-transitory computer-readable media, such as removable/non-removable, volatile/non-volatile computer storage media. FIG. 7 shows, for example a disk storage 724. Disk storage 724 includes, but is not limited to, devices like a magnetic disk drive, floppy disk drive, tape drive, Jaz drive, Zip drive, LS-100 drive, flash memory card, or memory stick.

In addition, disk storage 724 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 724 to the system bus 718, a removable or non-removable interface is typically used such as interface 726.

It is to be appreciated that FIG. 7 describes software that acts as an intermediary between users and the basic computer resources described in the suitable operating environment 700. Such software includes an operating system 728. Operating system 728, which can be stored on disk storage 724, acts to control and allocate resources of the computer system 712.

System applications 730 take advantage of the management of resources by operating system 728 through program modules 732 and program data 734 stored either in system memory 716 or on disk storage 724. It is to be appreciated that the claimed subject matter can be implemented with various operating systems or combinations of operating systems.

A user enters commands or information into the computer 712 through input device(s) 736. Input devices 736 include, but are not limited to, a pointing device (such as a mouse, trackball, stylus, or the like), a keyboard, a microphone, a joystick, a satellite dish, a scanner, a TV tuner card, a digital camera, a digital video camera, a web camera, and/or the like. The input devices 736 connect to the processing unit 714 through the system bus 718 via interface port(s) 738. Interface port(s) 738 include, for example, a serial port, a parallel port, a game port, and a universal serial bus (USB).

Output device(s) 740 use some of the same type of ports as input device(s) 736. Thus, for example, a USB port may be used to provide input to the computer 712, and to output information from computer 712 to an output device 740.

Output adapter 742 is provided to illustrate that there are some output devices 740 like monitors, speakers, and printers, among other output devices 740, which are accessible via adapters. The output adapters 742 include, by way of illustration and not limitation, video and sound cards that provide a means of connection between the output device 740 and the system bus 718. It can be noted that other devices and/or systems of devices provide both input and output capabilities such as remote computer(s) 744.

The computer 712 can be a server hosting a search engine web site in a networked environment using logical connections to one or more remote computers, such as remote computer(s) 744. The remote computer(s) 744 may be client systems configured with web browsers, PC applications, mobile phone applications, and the like, to allow users to perform asynchronous searches, as discussed herein. For example, remote computer 744 may include a web browser that the viewer uses to request asynchronous searches and view asynchronous search results.

The remote computer(s) 744 can be a personal computer, a server, a router, a network PC, a workstation, a microprocessor based appliance, a mobile phone, a peer device or other common network node and the like, and typically includes many or all of the elements described relative to the computer 712.

For purposes of brevity, only a memory storage device 746 is illustrated with remote computer(s) 744. Remote computer(s) 744 is logically connected to the computer 712 through a network interface 748 and then physically connected via a communication connection 750.

Network interface 748 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 750 refers to the hardware/software employed to connect the network interface 748 to the bus 718. While communication connection 750 is shown for illustrative clarity inside computer 712, it can also be external to the computer 712. The hardware/software for connection to the network interface 748 may include, for exemplary purposes only, internal and external technologies such as, mobile phone switches, modems including regular telephone grade modems, cable modems and DSL modems, ISDN adapters, and Ethernet cards.

An exemplary embodiment of the computer 712 may comprise a server hosting a search engine website. The server may be configured to provide initial search results and to request asynchronous search results.

An exemplary processing unit 714 for the server may be a computing cluster comprising Intel® Xeon CPUs. The disk storage 724 may comprise an enterprise data storage system, for example, holding thousands of impressions.

Exemplary embodiments of the subject innovation may display an icon on the remote computer(s) 744 that is clickable to request asynchronous searches. Asynchronous search results may be requested from human or crowd-sourcing resources. Results may be made available via a non-intrusive icon on the remote computer(s) 744.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable storage media having computer-executable instructions for performing the acts and/or events of the various methods of the claimed subject matter.

There are multiple ways of implementing the subject innovation, e.g., an appropriate API, tool kit, driver code, operating system, control, standalone or downloadable software object, etc., which enables applications and services to use the techniques described herein. The claimed subject matter contemplates the use from the standpoint of an API (or other software object), as well as from a software or hardware object that operates according to the techniques set forth herein. Thus, various implementations of the subject innovation described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical).

Additionally, it can be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A method for generating asynchronous search results, comprising:
receiving an asynchronous search request from a browser;
requesting asynchronous results from an asynchronous query system;
performing a synchronous search based on the asynchronous search request, generating initial results;
providing the initial results to the browser; and
providing, to the browser, an estimated completion time when the asynchronous results are made available.

2. The method recited in claim 1, comprising generating the asynchronous search request, wherein generating the asynchronous search request comprises:
receiving a request for a search site from a user of the browser, wherein the search site comprises one or more servers that support the asynchronous search request;
submitting a request to the search site, comprising:
a user agent string; and
a parameter asking whether the search site supports the asynchronous search request;
receiving a response from the search site indicating that the search site supports the asynchronous search request; and
displaying an icon clickable to send the asynchronous search request to the search site.

3. The method recited in claim 2, comprising:
receiving one or more search terms;
receiving a click of the icon; and
generating the asynchronous search request comprising the search terms and an asynchronous search parameter.

4. The method recited in claim 1, comprising:
determining that the asynchronous results are available;
requesting the asynchronous results;
notifying a user that the asynchronous results are available; and
displaying the asynchronous results.

5. The method recited in claim 4, wherein determining that the asynchronous results are available comprises:
creating a local timer that expires after the estimated completion time; and
sending, using a timer callback, a URL request to the search site specifying an identifier for the asynchronous search results, wherein functionality of the browser comprises the timer callback.

6. The method recited in claim 4, wherein notifying the user comprises:
sending an email to the user;
creating a non-intrusive notification on the browser; or
combinations thereof.

7. The method recited in claim 6, wherein displaying the asynchronous results comprises displaying the asynchronous results on a non-intrusive tab of the browser.

8. A system for generating asynchronous search results, comprising:
a processing unit; and
a system memory, wherein the system memory comprises code configured to direct the processing unit to:
determine that asynchronous results are available;
request the asynchronous results;
notify a user that the asynchronous results are available; and
display the asynchronous results.

9. The system recited in claim 8, wherein the code configured to direct the processing unit to determine that the asynchronous results are available comprises code configured to direct the processing unit to:
create a local timer that expires after the estimated completion time; and
send, using a timer callback, a URL request to the search site specifying an identifier for the asynchronous search results, wherein functionality of the browser comprises the timer callback.

10. The system recited in claim 9, wherein the code is configured to direct the processing unit to:
receive an asynchronous search request from a browser;
request asynchronous results from an asynchronous query system;
perform a synchronous search based on the asynchronous search request, generating initial results;
provide the initial results to the browser; and
provide, to the browser, a message indicating that the asynchronous results are pending.

11. The system recited in claim 10, wherein the message specifies an estimated completion time when the asynchronous results are made available.

12. The system recited in claim 11, wherein the code is configured to direct the processing unit to:
display the initial results in the browser; and
display the estimated completion time in the browser.

13. The system recited in claim 12, wherein the code is configured to direct the processing unit to:
receive a request for a search site from a user of the browser, wherein the search site comprises one or more servers that support the asynchronous search request;
submit a request to the search site, wherein the request to the search site comprises:
a user agent string; and
a parameter asking whether the search site supports an asynchronous search request;
receive a response from the search site indicating that the search site supports the asynchronous search request; and
display an icon clickable to send the asynchronous search request to the search site.

14. The system recited in claim 13, wherein the code is configured to direct the processing unit to:
receive one or more search terms;
receive a click of the icon; and
generate the asynchronous search request comprising the search terms and an asynchronous search parameter.

15. One or more computer-readable storage media, comprising code configured to direct a processing unit to:
receive a request for a search site from a user of the browser, wherein the search site comprises one or more servers that support an asynchronous search request;
submit a request to the search site;
receive a response from the search site indicating that the search site supports the asynchronous search request; and
display an icon clickable to send the asynchronous search request to the search site.
receive one or more search terms;
receive a click of the icon;
generate the asynchronous search request comprising the search terms and an asynchronous search parameter;
receive an asynchronous search request from a browser;
request asynchronous results from an asynchronous query system;
perform a synchronous search based on the asynchronous search request to generate initial results;
provide the initial results to the browser; and
provide, to the browser, a message indicating the asynchronous results are pending.

16. The computer-readable storage media recited in claim 15, wherein the code is configured to direct the processing unit to:
display the initial results in the browser;
display the message in the browser;
determine that the asynchronous results are available;
request the asynchronous results;
notify a user that the asynchronous results are available; and
display the asynchronous results.

17. The computer-readable storage media of claim 16, wherein the code configured to determine that the asynchronous results are available comprises code configured to direct the processing unit to:
create a local timer that expires after the estimated completion time; and
send, using a timer callback, a URL request to the search site specifying an identifier for the asynchronous search results, wherein functionality of the browser comprises the timer callback.

18. The computer-readable storage media recited in claim 15, wherein the message specifies an estimated completion time when the asynchronous results are made available.

19. The computer-readable storage media recited in claim 15 wherein the request to the search site comprises:
a user agent string; and
a parameter asking whether the search site supports the asynchronous search request.

20. The computer-readable storage media recited in claim 15, comprising code configured to direct the processing unit to generate the asynchronous results by performing an asynchronous search based on the asynchronous search request.
